(19) United States
(12) Patent Application Publication
(10) Pub. No.: US 2017/0056889 A1
(43) Pub. Date: Mar. 2, 2017

(54) GRAVITY AIDED GRINDING MILL APPARATUS AND METHOD

(71) Applicant: Bayram Suha Aksoy, Sandersville, GA (US)

(72) Inventor: Bayram Suha Aksoy, Sandersville, GA (US)

(21) Appl. No.: 15/220,324

(22) Filed: Jul. 26, 2016

Related U.S. Application Data
(60) Provisional application No. 62/345,084, filed on Jun. 3, 2016.
(60) Provisional application No. 62/209,967, filed on Aug. 26, 2015.

(51) Int. Cl. B02C 19/00; B02C 23/18; B02C 23/10

(52) U.S. Cl. CPC B02C 19/00; B02C 23/10; B02C 23/18

(57) ABSTRACT

In some embodiments, a gravity aided grinding mill apparatus may include an intake for receiving a grinding media and a grindable material. A first elongated runner may be in communication with the intake, and a first doubleback coupling may be in communication with the first elongated runner. Grinding media and grindable material may travel in a first direction across the first elongated runner into the first doubleback coupling and the first doubleback coupling may change the direction of travel of grinding media and grindable material into a second direction. A second elongated runner may be in communication with the first doubleback coupling, and the second elongated runner may receive the grinding media and grindable material traveling in the second direction from the first doubleback coupling. The grinding media and grindable material may be communicated from an output and across a grizzly screen.

### CROSS REFERENCE TO RELATED APPLICATIONS

This application claims priority to and the benefit of the filing date of U.S. Provisional Application No. 62/345,084, filed on Jun. 3, 2016, entitled “GRAVITY AID GRINDING MILL APPARATUS AND METHOD”, as well as U.S. Provisional Application No. 62/209,967 filed Aug. 26, 2015, both of which are hereby incorporated by reference in their entirety.

### FIELD OF THE INVENTION

This patent specification relates to the field of grinding mill apparatuses and methods. More specifically, this patent specification relates to grinding mill systems and methods with reduced energy requirements and increased grinding efficiency.

### BACKGROUND

Comminution, the action of reducing a material, such as an ore, to minute particles or fragments, in its earliest stages is commonly carried out in order to make the freshly excavated material easier to handle by scrapers, conveyors, and ore carriers and may include crushing and/or grinding of the material. Crushing is accomplished by compression of the ore against rigid surfaces, or by impact against surfaces in a constrained motion path such as by tumbling. Tumbling mills for size reduction may include the use of steel rods (rod mills), balls (ball mills), or sized ore (AG & SAG mills) as a grinding media each of which alone or in combination may be selected depending upon the size and energy considerations.

Grinding is accomplished by abrasion and impact of the ore by the free motion of unconnected media such as rods, balls, or pebbles. Grinding is frequently performed wet to provide a slurry feed to the concentration process, although dry grinding has limited applications. There is an overlapping size area where it is possible to crush or grind the ore. From a number of case studies, it appears that at the fine end of crushing operations equivalent reduction can be achieved for roughly half the energy and costs required by grinding mills.

As a common knowledge, grinding mills are utilized to reduce the size of solid materials in a mineral processing plant such that they can be further processed, for example, froth flotation, magnetic separation, gravity separation, etc. In agricultural or food industries, the products such as dry wheat, dry vegetables, peppers, corn, nuts etc. are ground to certain particle sizes. The size reduction is accomplished by means of apparatuses which are commonly used in industrial applications such as ball mills, rod mills, pebble mills, etc.

The conventional apparatuses and methods of grinding minerals include: Ball mills, rod mills, pebble mills which are constructed by a cylindrical shape with different length-diameter ratios and are rotated to provide a tumbling action of grinding media and a mineral to be ground in the mill. In general operation procedure, the grinding media is placed into the mill prior to the grinding then a mineral ore (dry or slurry form) is fed in the mill from one end of the mill and a mineral is ground during this tumbling action product collected from the other end. Conventional ball mills are generally characterized with shorter length to diameter ratio of the magnitude of 1.5 to 1.0. Ball mills with ratios of 3 to 5 are designated as a tubular mill. Ball mills are classified according to the type of discharge the mill equipped with. These two types of discharges are a) Grade and b) Overflow discharge.

There are many issues associated with these apparatus and methods of grinding a mineral ore. For example, the milling is the most expensive units operation in the mineral processing plant. Any reduction of the energy consumption will result in a big savings. Additionally, most of the ball mill application on minerals ore results creating very fine particles which may not be desirable. Furthermore, the consumption of grinding media and liners tends to be very costly. Also, since the ball mill has moving parts, its maintenance will be costly (parts, work time, and downtimes), and having longer downtimes in the plant operations will end up the major issues. In addition, troublesome grinding balls, which are degraded in size after used a long period of time, cannot be separated easily from the mill output and end up causing problems in the down streams during the operation.

Therefore, a need exists for novel grinding mill apparatuses and methods. There is a further need for novel grinding mill systems and methods with reduced energy requirements and increased grinding efficiency. Finally, there exists a need for novel grinding mill systems and methods which are able to provide decreased downtimes in the plant operations and decreased maintenance costs.

### BRIEF SUMMARY OF THE INVENTION

A gravity aided grinding mill apparatus is provided which may be used to grind, macerate, or pulverize a grindable material to a desired particle size. In some embodiments, the apparatus may include an intake for receiving a grinding media and a grindable material. A first elongated runner may be in communication with the intake, and a first doubleback coupling may be in communication with the first elongated runner. Grinding media and grindable material may travel in a first direction across the first elongated runner into the first doubleback coupling and the first doubleback coupling may change the direction of travel of grinding media and grindable material into a second direction. A second elongated runner may be in communication with the first doubleback coupling, and the second elongated runner may receive the grinding media and grindable material traveling in the second direction from the first doubleback coupling. The grinding media and grindable material may be communicated from an output and across a grizzly screen. The grizzly screen may comprise one or more exit apertures each of which may be smaller in size than the grinding media. The grinding media may be mixed or otherwise in contact with the grindable material. When the grinding media and grindable material change from a first direction to a second direction, such as within a first doubleback coupling, the grinding media may impact particles or pieces of the grindable material thereby breaking the grindable material into smaller particles or pieces.

According to one aspect consistent with the principles of the invention, a gravity aided grinding method is provided. The method may be used to grind, macerate, or pulverize a grindable material to a desired particle size using a gravity aided grinding mill apparatus. In some embodiments, the method may include the steps of: communicating a milling mixture into a first elongated runner; gravitationally accelerating the milling mixture in a first direction along the first elongated runner into a first doubleback coupling; changing the direction of travel of the milling mixture from the first direction to a second direction within the first doubleback coupling; communicating the milling mixture from the first doubleback coupling into a second elongated runner; gravitationally accelerating the milling mixture in a second direction along the second elongated runner; communicating the milling mixture from the second elongated runner onto a grizzly screen; and optionally communicating grinding media from the milling mixture to the intake via a feeder device.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a side elevation view of an example of a gravity aided grinding mill apparatus according to various embodiments described herein.

FIG. 2—FIG. 2 illustrates a side perspective view of an alternative example of a gravity aided grinding mill apparatus according to various embodiments described herein.

FIG. 3—FIG. 3 shows a side elevation view of a further alternative example of a gravity aided grinding mill apparatus according to various embodiments described herein.

FIG. 4—FIG. 4 depicts a schematic diagram of an example of a gravity aided grinding mill apparatus according to various embodiments described herein.

FIG. 5—FIG. 5 illustrates a block diagram of an example of a gravity aided grinding method according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

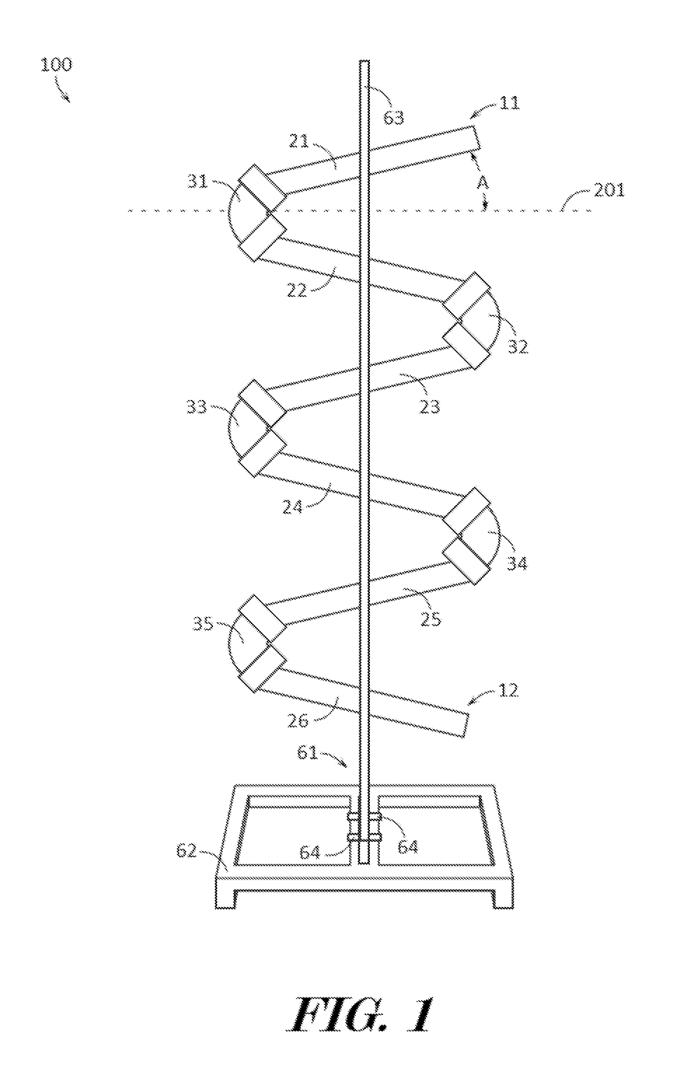

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

New grinding mill apparatuses and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

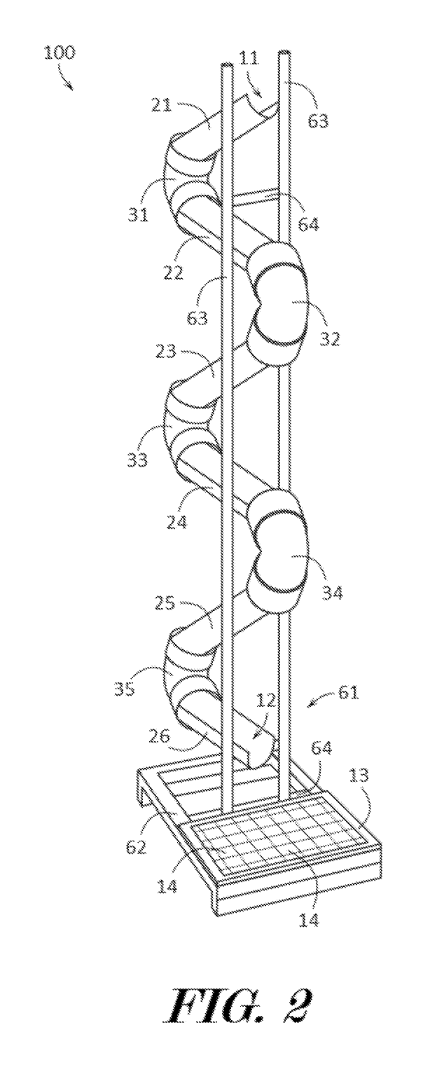

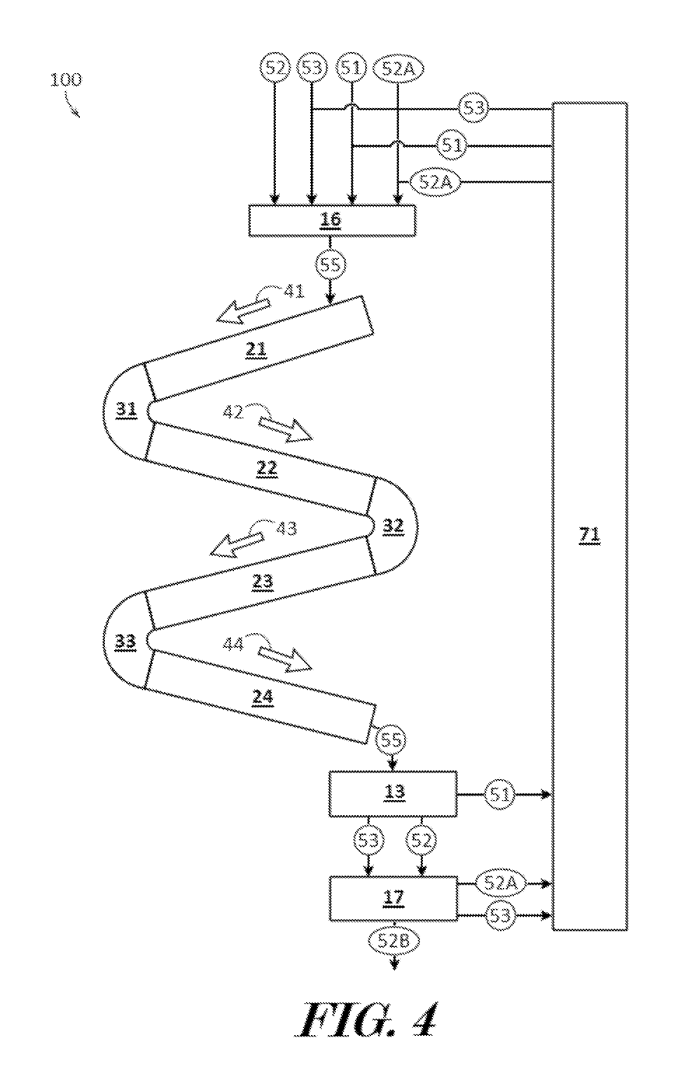

The present invention will now be described by example and through referencing the appended figures representing preferred and alternative embodiments. FIG. 1 illustrates an example of a gravity aided grinding mill apparatus (“the apparatus”) 100 according to various embodiments. In this example, the apparatus 100 comprises an intake 11 for receiving a grinding media 51 (FIG. 4) and a grindable material 52 (FIG. 4). A first elongated runner 21 may be in communication with the intake 11, and a first doubleback coupling 31 may be in communication with the first elongated runner 21. Grinding media 51 and grindable material 52 may travel in a first direction 41 (FIG. 4) across the first elongated runner 21, into the first doubleback coupling 31, and the first doubleback coupling 31 may change the direction of travel of grinding media and grindable material into a second direction 42 (FIG. 4). A second elongated runner 22 may be in communication with the first doubleback coupling 31, and the second elongated runner 22 may receive the grinding media 51 and grindable material 52 traveling in the second direction 42 from the first doubleback coupling 31. The grinding media 51 and grindable material 52 may be communicated from an output 12 and across a grizzly screen 13 (FIGS. 2 and 4). The grizzly screen 13 may comprise one or more exit apertures 14 (FIG. 2) each of which may be smaller in size than the grinding media 51. The grinding media 51 may be mixed or otherwise in contact with the grindable material 52. When the grinding media 51 and grindable material 52 change from a first direction 41 to a second direction 42, such as within a first doubleback coupling 31, the grinding media 51 may impact particles or pieces of the grindable material 52 thereby breaking the grindable material 52 into smaller particles or pieces.

In some embodiments, the grinding media 51 may be generally spherical in shape and comprise balls which may be made from iron, steel, ceramic, combinations thereof, or any other suitable material. The grinding media 51 may be of any size including about the size of a small marble, tennis ball, baseball, softball, basketball, bowling ball, or any other suitable size. The grinding media 51 may move within the apparatus 100 macerating/pulverizing the grindable material 52 to a desired particle size with each change in direction provided by a doubleback coupling.

The grindable material 52 may comprise any material which is desired to undergo a reduction in particle size and the grinding media 51 may be selected based on the grindable material 52. For example, grindable material 52 may comprise food products, such as dry wheat, dry vegetables, peppers, corn, nuts etc., and a generally smaller sized and/or less hard grinding media 51 may be used. In another example, grindable material 52 may comprise mineral ores and matters, such as iron ore, gold ore, stone aggregate, or any other valuable minerals or other geological materials and a generally larger sized and/or harder grinding media 51 may be used.

In some embodiments, the size ratio of the grinding media 51 to grindable material 52 may be between 5:1 and 25:1. For example, the size of the grinding media 51 may be approximately five to twenty five times the size of the grindable material 52. In further embodiments, the size ratio of the grinding media 51 to grindable material 52 may be between 10:1 and 20:1. For example, the size of the grinding media 51 may be approximately ten to twenty times the size of the grindable material 52. In alternative embodiments, the size ratio of the grinding media 51 to grindable material 52 may be between 25:1 and 1:1. For example, the size of the grinding media 51 may be approximately one twenty fifth to equal the size of the grindable material 52.

In some embodiments, the apparatus 100 may comprise two or more runners. For example, in addition to a first elongated runner 21 and a second elongated runner 22 the apparatus 100 may comprise a third elongated runner 23, a fourth elongated runner 24, a fifth elongated runner 25, a sixth elongated runner 26, a seventh elongated runner, an eighth elongated runner, a ninth elongated runner, a tenth elongated runner, and/or any other number of elongated runners. The first elongated runner 21 may be coupled to a first doubleback coupling 31, while one or more subsequent elongated runners may be coupled to two or more doubleback couplings. For example, in addition to a first doubleback coupling 31 the apparatus 100 may comprise a second doubleback coupling 32, a third doubleback coupling 33, a fourth doubleback coupling 34, a fifth doubleback coupling 35, a sixth doubleback coupling, a seventh doubleback coupling, an eighth doubleback coupling, a ninth doubleback coupling, a tenth doubleback coupling, and/or any other number of doubleback couplings.

Each elongated runner may be in communication with one or more doubleback couplings. For example and in some embodiments, a first elongated runner 21 may be in communication with a first doubleback coupling 31 and the first doubleback coupling 31 may also be in communication with a second elongated runner 22. A second doubleback coupling 32 may be in communication with the second elongated runner 22 and a third elongated runner 23. A third doubleback coupling 33 may be in communication with the third elongated runner 23 and a fourth elongated runner 24. A fourth doubleback coupling 34 may be in communication with the fourth elongated runner 24 and a fifth elongated runner 25. A fifth doubleback coupling 35 may be in communication with the fifth elongated runner 25 and a sixth elongated runner 26. Preferably, the apparatus 100 may comprise a greater number of elongated runners than doubleback couplings, but the apparatus 100 may comprise any number or ratio of elongated runners and doubleback couplings.

An elongated runner 21, 22, 23, 24, 25, 26, may function to convey or direct grinding media 51, grindable material 52, and other materials such as a grinding fluid 53 from one location to another location. In some embodiments, elongated runners 21, 22, 23, 24, 25, 26, may comprise an elongated “V” shape, elongated “U” shape, or any other elongated shape which may form a channel or trough through which grinding media 51, grindable material 52, and other materials transported, conveyed, or directed. As an example, one or more elongated runners 21, 22, 23, 24, 25, 26, may be formed from a section of pipe which may be cut in half lengthwise and open as shown in (FIG. 2). In alternative embodiments, one or more elongated runners 21, 22, 23, 24, 25, 26, may be formed from a section of pipe that is closed. Preferably, one or more elongated runners 21, 22, 23, 24, 25, 26, may be generally linear in shape and convey or direct grinding media 51, grindable material 52, and other materials in a generally linear direction. In other embodiments, one or more elongated runners 21, 22, 23, 24, 25, 26, may be generally curved in shape and convey or direct grinding media 51, grindable material 52, and other materials in a generally curved direction. Elongated runners 21, 22, 23, 24, 25, 26, may be made from any material, such as plastic, metal and metal alloys, wood, resins, composite materials, and combinations of materials which may be suitable for conveying or directing grinding media 51, grindable material 52, and other materials.

Similar to an elongated runner 21, 22, 23, 24, 25, 26, a doubleback coupling 31, 32, 33, 34, 35, may function to convey or direct grinding media 51, grindable material 52, and other materials such as a grinding fluid 53 from one location to another location, however, a doubleback coupling 31, 32, 33, 34, 35, may be configured to change the direction of travel, such as from a first direction to a second direction, of grinding media 51, grindable material 52, and other materials which enter or pass through the doubleback coupling 31, 32, 33, 34, 35. In some embodiments, doubleback coupling 31, 32, 33, 34, 35, may comprise an elbow shape, “L” shape, “C” shape, “U” shape, or any other shape which may be used to change the direction of travel of grinding media 51, grindable material 52, and other materials transported, conveyed, or directed by the doubleback coupling 31, 32, 33, 34, 35. As an example, one or more doubleback couplings 31, 32, 33, 34, 35, may be formed from a section of elbow joint pipe as shown in (FIG. 2). In alternative embodiments, one or more doubleback coupling 31, 32, 33, 34, 35, may be formed from a vertical or angled barrier against which grinding media 51, grindable material 52, and other materials may impact against, thereby changing the direction of travel of the grinding media 51, grindable material 52, and other materials, and then be directed into a elongated runner 21, 22, 23, 24, 25, 26. Doubleback couplings 31, 32, 33, 34, 35, may be made from any material, such as plastic, metal and metal alloys, wood, resins, composite materials, and combinations of materials which may be suitable for changing the direction of travel, conveying, and/or directing grinding media 51, grindable material 52, and other materials.

In preferred embodiments, one or more elongated runners 21, 22, 23, 24, 25, 26, may be angled between −5 and −85 degrees relative to horizontal 201 (as shown with Angle A) so that the action of gravity may facilitate or enable the movement of grinding media 51, grindable material 52, and other materials across or through the elongated runners 21, 22, 23, 24, 25, 26. Horizontal 201 may be defined as a level plane that is perpendicularly oriented to the force of gravity and may be likened to the plane formed by a level floor or ground surface. In preferred embodiments, one or more elongated runners 21, 22, 23, 24, 25, 26, may be angled between −10 and −45 degrees relative to horizontal 201 (as shown with Angle A).

It should be appreciated that the greater the negative angle that an elongated runner 21, 22, 23, 24, 25, 26, is angled with relative to horizontal 201, the greater the action of gravity on the movement of grinding media 51, grindable material 52, and other materials across or through the elongated runner 21, 22, 23, 24, 25, 26, and the faster the movement of grinding media 51, grindable material 52, and other materials across or through the elongated runner 21, 22, 23, 24, 25, 26, will be. Conversely, the lesser the negative angle that an elongated runner 21, 22, 23, 24, 25, 26, is angled with relative to horizontal 201, the lesser the action of gravity on the movement of grinding media 51, grindable material 52, and other materials across or through the elongated runner 21, 22, 23, 24, 25, 26, and the slower the movement of grinding media 51, grindable material 52, and other materials across or through the elongated runner 21, 22, 23, 24, 25, 26, will be.

Additionally, the length of an elongated runner 21, 22, 23, 24, 25, 26, will also affect the movement of grinding media 51, grindable material 52, and other materials across or through the elongated runner 21, 22, 23, 24, 25, 26. The greater the length of an elongated runner 21, 22, 23, 24, 25, 26, the greater the action of gravity on the movement of grinding media 51, grindable material 52, and other materials across or through the elongated runner 21, 22, 23, 24, 25, 26, and the faster the movement of grinding media 51, grindable material 52, and other materials across or through the elongated runner 21, 22, 23, 24, 25, 26, will be. The lesser the length of an elongated runner 21, 22, 23, 24, 25, 26, the lesser the action of gravity on the movement of grinding media 51, grindable material 52, and other materials across or through the elongated runner 21, 22, 23, 24, 25, 26, and the slower the movement of grinding media 51, grindable material 52, and other materials across or through the elongated runner 21, 22, 23, 24, 25, 26, will be.

As perhaps best shown by FIGS. 1-3 and in some embodiments, the apparatus 100 may be configured with a generally zigzag shape. For example, a first elongated runner 21 may be angled between −30 degrees relative to horizontal to the right, a second elongated runner 2 may be angled between −30 degrees relative to horizontal to the left, a third elongated runner 23 may be angled between −30 degrees relative to horizontal to the right, a fourth elongated runner 24 may be angled between −30 degrees relative to horizontal to the left, and so on. In other embodiments, the apparatus 100 may be configured in a triangle shape, a square shape, a rectangular shape, or any other shape by positioning the elongated runners 21, 22, 23, 24, 25, 26, and doubleback couplings 31, 32, 33, 34, 35, in various orientations. In still further embodiments, the apparatus 100 may be configured in a spiral shape or other curved shape using one or more curved elongated runners 21, 22, 23, 24, 25, 26, and/or doubleback couplings 31, 32, 33, 34, 35.

In some embodiments, the apparatus 100 may comprise an intake 11 and an output 12. Generally, an intake 11 may be where grinding media 51, grindable material 52, and other materials may be added or introduced into an elongated runner 21, 22, 23, 24, 25, 26, such as a first elongated runner 21, and/or into a doubleback coupling 31, 32, 33, 34, 35, such as a first doubleback coupling 31. An output 12 may be where grinding media 51, grindable material 52, and other materials me be removed from or exit an elongated runner 21, 22, 23, 24, 25, 26, such as the last elongated runner, and/or from a doubleback coupling 31, 32, 33, 34, 35, such as a last doubleback coupling. An intake 11 and an output 12 may be configured in a plurality of sizes and shapes and may optionally be formed as an opening or other access point on an elongated runner 21, 22, 23, 24, 25, 26, and/or a doubleback coupling 31, 32, 33, 34, 35.

In some embodiments, the apparatus 100 may comprise an “upper” or “top” elongated runner 21, 22, 23, 24, 25, 26, and/or an “upper” and/or “top” doubleback coupling 31, 32, 33, 34, 35. Also the apparatus 100 may comprise a “lower” or “bottom” elongated runner 21, 22, 23, 24, 25, 26, and/or a “lower” and/or “bottom” doubleback coupling 31, 32, 33, 34, 35. Generally, the upper elongated runner may be the first elongated runner 21 and the upper doubleback coupling may be the first doubleback coupling 31 either or both of which may comprise an intake 11 and which may communicate grinding media 51, grindable material 52, and other materials to lower or subsequent elongated runners 22, 23, 24, 25, 26, and/or doubleback couplings 32, 33, 34, 35, preferably facilitated by the action of gravity. In a similar manner, a bottom elongated runner may be any subsequent elongated runner 22, 23, 24, 25, 26, and a bottom doubleback coupling may be any subsequent elongated runner 22, 23, 24, 25, 26, either or both of which may comprise an output 12 and which may communicate grinding media 51, grindable material 52, and other materials to a grizzly screen 13 or other element described herein.

FIG. 2 illustrates a side perspective view of an alternative example of a gravity aided grinding mill apparatus 100 according to various embodiments described herein. In some embodiments, the apparatus 100 may comprise one or more grizzly screens 13 which may be used to separate grindable material 52 below a certain size threshold from grinding media 51 and grindable material 52 above a certain size threshold. In this manner a grizzly screen 13 may function as a filter for removing grindable material 52 from the system 100 that has been reduced to a desired size from grindable material 52 that required further size reduction. A grizzly screen 13 may comprise a grid or set of preferably parallel bars, optionally made of metal, which may be set in an inclined stationary frame, with a slope of −20 to −60 degrees relative to horizontal 201. A grizzly screen 13 may comprise one or more exit apertures 14 which may be of any shape and size. The size of the grinding media 51 may be larger than the exit apertures 14 so that grinding media 51 may not be removed from the apparatus 100. In some embodiments, one or more optional bars of a grizzly screen 13 may be shaped in such a way that the upper surface of the bar may be wider than the bottom surface, and hence the bars may be made fairly deep for strength without being choked by lumps passing part way through them. A coarse feed (say from a primary crusher) may be fed at the upper end of the grizzly. Large chunks may roll and slide to the lower end (tail discharge) while small lumps having size less than the exit apertures 14 in the bars may fall through the grizzly screen 13 and into a separate collector container 15 or the like.

As shown in FIGS. 1-3, the apparatus 100 may comprise a support structure 61 which may be used to support and position one or more elongated runners 21, 22, 23, 24, 25, 26, doubleback couplings 31, 32, 33, 34, 35, grizzly screens 13, and/or any other element discussed herein. In some embodiments, a support structure 61 may include a base 62 and one or more vertical supports 63 may be coupled to the base 62. A support structure 61 may include one or more horizontal supports 64. The elements of the support structure 61 may be coupled together and to one or more elongated runners 21, 22, 23, 24, 25, 26, doubleback couplings 31, 32, 33, 34, 35, grizzly screens 13, and/or any other element with one or more fasteners, welding, or any other suitable connection method.

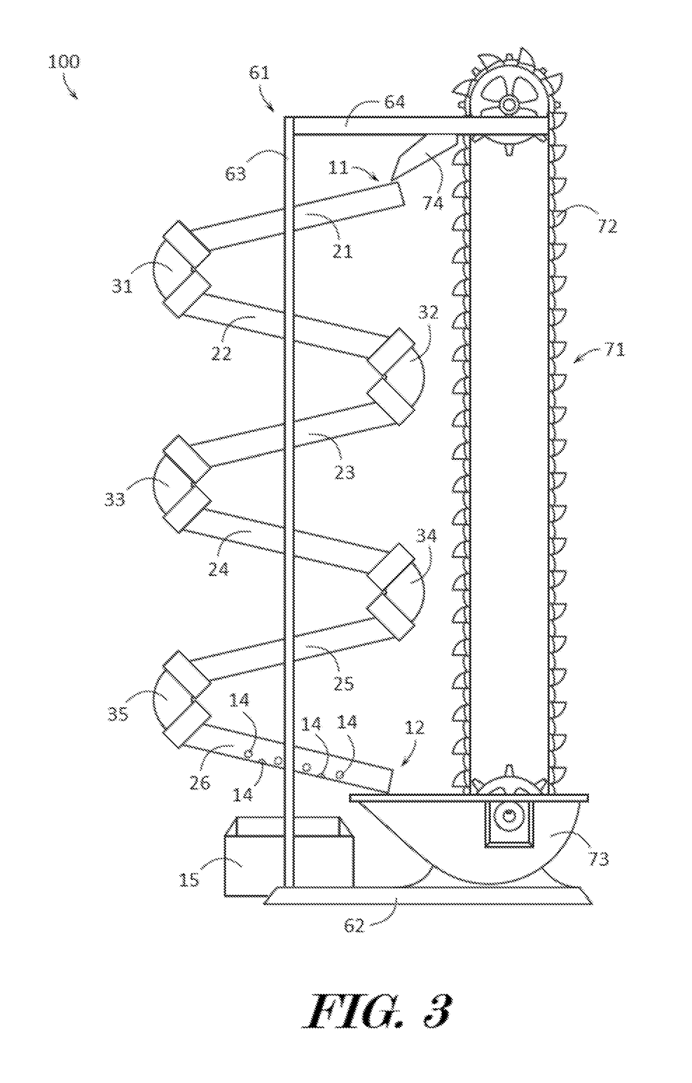

FIG. 3 shows a side elevation view of a further alternative example of a gravity aided grinding mill apparatus 100 according to various embodiments described herein. In some embodiments, the apparatus 100 may comprise a feeder device 71 which may be configured to communicate grinding media 51, grindable material 52, and/or other materials into an intake 11. In preferred embodiments, and as shown in FIG. 4, a feeder device 71 may be configured to communicate grinding media 51, grindable material 52, and/or other materials from a grizzly screen 13 to the intake 11. In some embodiments, a feeder device 71 may comprise a bucket conveyor feeder device, as illustrated in FIG. 3, having one or more such as a plurality of buckets 72 which may retrieve grinding media 51, grindable material 52, and/or other materials from a reservoir 73 and deposit them in the intake 11 such as by way of a chute 74 or other sloping channel or slide for conveying things to a lower level. In alternative embodiments, a feeder device 71 may comprise a gravity conveyor, gravity skatewheel conveyor, belt conveyor, wire mesh conveyors, plastic belt conveyors, flexible conveyors, vertical conveyors, spiral conveyors, vibrating conveyors, pneumatic conveyors, electric track vehicle systems, belt driven live roller conveyors, lineshaft roller conveyor, chain conveyor, screw conveyor or auger conveyor, chain driven live roller conveyor, overhead i-beam conveyors, dust proof conveyors, pharmaceutical conveyors, automotive conveyors, overland conveyor, drag conveyor, tube conveyor, or any other method or device suitable for moving solid and/or liquid materials.

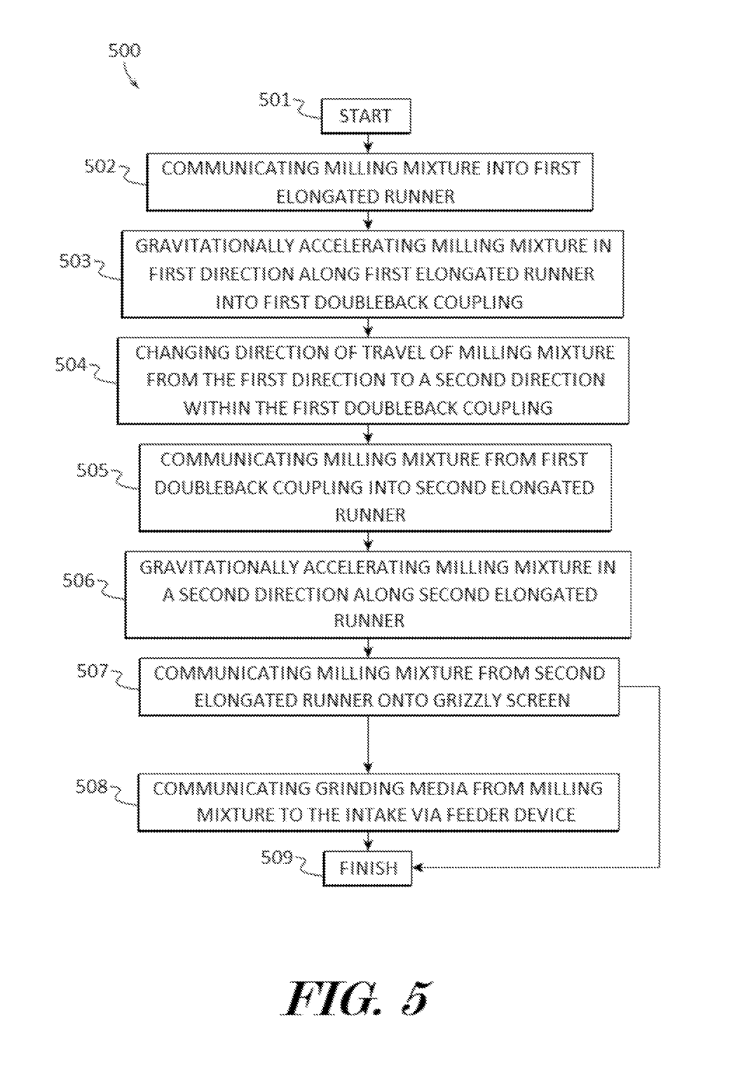

In some embodiments, one or more elongated runners 21, 22, 23, 24, 25, 26, may comprise one or more such as a plurality of exit apertures 14. A collector container 15 may be positioned below the exit apertures 14 so that any grinding media 51, grindable material 52, and other materials which are smaller in size than the exit apertures 14 may fall through the exit apertures 14 and into the collector container 15. In this manner, an elongated runner 21, 22, 23, 24, 25, 26, comprising one or more apertures 14 may function as a grizzly screen 13, separator 17 (FIG. 5), and/or the like.

FIG. 4 depicts a schematic diagram of an example of a gravity aided grinding mill apparatus 100 according to various embodiments described herein. In some embodiments, the apparatus 100 may comprise an optional distributor 16 which may function to control the rate or addition of grinding media 51, grindable material 52, and other materials into an intake 11 of the apparatus 100. The grinding media 51, grindable material 52, and other materials may form a milling mixture 55 which may then be communicated through or across one or more elongated runners 21, 22, 23, 24, 25, 26, and doubleback couplings 31, 32, 33, 34, 35. In some embodiments, a milling mixture 55 may comprise grinding media 51 and grindable material 52. In further embodiments, a milling mixture 55 may further comprise grinding fluid 53 into which the grinding media 51 grindable material 52 may be incorporated into. A grinding fluid 53 may allow the apparatus 100 to perform wet grinding, such as with a slurry, and may comprise water or any other suitable fluid for wet grinding of a grindable material 52. Optionally, a feeder device 71 and/or a distributor 16 may comprise a slurry pump or other pump suitable for pumping grinding media 51 and grindable material 52 which are incorporated into a grinding fluid 53. In preferred embodiments, a milling mixture 55 comprising pumping grinding media 51, grindable material 52, and grinding fluid 53 may have a pulp density of between 5 to 65 percent solids, and more preferably a pulp density of between 10 to 35 percent solids.

As perhaps best shown by the schematic diagram of the apparatus 100, grinding media 51, grindable material 52, and/or grinding fluid 53 may, optionally be passed through a distributor 16, be incorporated into a milling mixture 55 which may be added or introduced into an intake 11. The intake 11 may communicate the milling mixture 55 into a first elongated runner 21 which may be angled between −5 and −85 degrees relative to horizontal 201 (FIG. 1). The milling mixture 55 may move or be communicated in a first direction 41 across the first elongated runner 21 facilitated by the force of gravity. The first elongated runner 21 may communicate the milling mixture 55 into a first doubleback coupling 31 which may change the direction of travel of the milling mixture 55 from the first direction 41 to a second direction 42. The milling mixture 55 may be communicated from the first doubleback coupling 31 to a second elongated runner 22 and it may continue moving or being communicated in the second direction 42 across the second elongated runner 22 facilitated by the force of gravity. In some embodiments, the second elongated runner 22 may communicate the milling mixture 55 directly to the output 12.

It should be noted that a first direction 41 may be defined as any direction that is different than the second direction 42. Optionally, the first direction 41 may be the same or similar to any direction subsequent to the second direction 42 such as a third direction 43, fourth direction 44, fifth direction, sixth direction, seventh direction, and so on. Similarly, a second direction 42 may be defined as any direction that is different than the first direction 41 and the third direction 43. Also, the second direction 42 may be the same or similar to any direction subsequent to the third direction 43 such as a fourth direction 44, fifth direction, sixth direction, seventh direction, and so on.

In alternative embodiments, the second elongated runner 22 may communicate the milling mixture 55 to the output 12 by way of one or more other doubleback couplings 32, 33, 34, 35, and/or one or more other elongated runners 23, 24, 25, 26. For example, the second elongated runner 22 may communicate the milling mixture 55 into a second doubleback coupling 32 which may change the direction of travel of the milling mixture 55 from the second direction 42 to a third direction 43. The milling mixture 55 may be communicated from the second doubleback coupling 32 to a third elongated runner 23 and it may continue moving or being communicated in the third direction 43 across the third elongated runner 23 facilitated by the force of gravity. The third elongated runner 23 may communicate the milling mixture 55 into a third doubleback coupling 33 which may change the direction of travel of the milling mixture 55 from the third direction 43 to a fourth direction 44. The milling mixture 55 may be communicated from the third doubleback coupling 33 to a fourth elongated runner 24 and it may continue moving or being communicated in the fourth direction 44 across the fourth elongated runner 24 facilitated by the force of gravity to the output 12.

Once the milling mixture 55 reaches the output 12, it may be communicated onto or across a grizzly screen 13 which may separate grinding media 51 from the grindable material 52 and optional grinding fluid 53. The separated grinding media 51 may then be communicated into a feeder device 71. In some embodiments, the apparatus 100 may comprise a separator 17 which may separate overflow grindable material 52A, and optionally grinding fluid 53, from underflow grindable material 52B. Generally, overflow grindable material 52A may comprise grindable material 52 having a size that is larger than desired and therefore requires further size reduction processing, while underflow grindable material 52B may comprise grindable material 52 having a size that is at or less than desired and therefore requires no further size reduction processing. In preferred embodiments, underflow grindable material 52B, and optionally grinding fluid 53, may be removed from the apparatus 100 by a separator 17 which may comprise a conical plate centrifuge, a plurality of exit apertures 14, or any other suitable device or method for separating materials of various sizes and optionally liquids.

In some embodiments, the overflow grindable material 52A and optional grinding fluid 53 may be communicated from the grizzly screen 13 and/or separator 17 to the feeder device 71. Once communicated into the feeder device 71, grinding media 51, overflow grindable material 52A, and optional grinding fluid 53 may then be communicated into the intake 11, such as by way of a distributor 16, for reprocessing.

FIG. 5 illustrates a block diagram of an example of a gravity aided grinding method (“the method”) 500 according to various embodiments described herein. The method 500 may be used to grind, macerate, or pulverize a grindable material 52 to a desired particle size using a gravity aided grinding mill apparatus 100 (FIGS. 1-4).

In some embodiments, the method 500 may start 501 and a milling mixture 55 may be communicated into the first elongated runner 21 of the apparatus 100 preferably via the intake 11 in step 502. The milling mixture 55 may comprise a grinding media 51 and a grindable material 52. Preferably, the size ratio of the grinding media 51 to grindable material 52 size is between 5:1 and 25:1. In further embodiments, the milling mixture 55 may comprise a grinding media 51, a grindable material 52, and a grinding fluid 53. In still further embodiments, the grinding media 51 and grindable material 52 may be incorporated into a grinding fluid 53 so that the milling mixture 55 comprises a pulp density of the between 5 to 65 percent solids.

In step 503, the milling mixture 55 may be gravitationally accelerated in a first direction 41 (FIG. 4) along a first elongated runner 21 and into a first doubleback coupling 31. In some embodiments, the first elongated runner 21 may be angled between −5 and −85 degrees relative to horizontal 201 (FIG. 1) to enable or facilitate the action of gravity on the milling mixture 55 as it travels across the first elongated runner 21 and is communicated into the first doubleback coupling 31.

Next in step 504, the direction of travel of the milling mixture 55 may be changed from the first direction 41 to a second direction 42 within or by the first doubleback coupling 31. In some embodiments, the second direction 42 may be any direction that is different than the first direction 41 and may further be defined as any direction of travel that ends or would end in the same location as the first direction 41.

Continuing to step 505, the milling mixture 55 may be communicated from the first doubleback coupling 31 into or onto the second elongated runner 52. In some embodiments, the first doubleback coupling 31 may be coupled directly to the second elongated runner 52 so that the milling mixture 55 may be directly communicated from the first doubleback coupling 31 into or onto the second elongated runner 52. In other embodiments, the apparatus 100 may comprise a funnel, chute, conveyor, feeder device 71, or any other suitable conveyance which may be used to communicate the milling mixture 55 from the first doubleback coupling 31 into or onto the second elongated runner 52.

In step 506, the milling mixture 55 may be gravitationally accelerated in a second direction 42 along the second elongated runner 22. In some embodiments, the second elongated runner 22 may be angled between −5 and −85 degrees relative to horizontal 201 to enable or facilitate the action of gravity on the milling mixture 55 as it travels across the second elongated runner 22.

Next, the milling mixture 55 may be communicated from the second elongated runner 22 onto a grizzly screen 13, comprising one or more exit apertures which are smaller in size than the grinding media 51, optionally via the output 13. In some embodiments, the milling mixture 55 may be communicated directly from the second elongated runner 22 onto the grizzly screen 13. In other embodiments, the apparatus 100 may comprise a funnel, chute, conveyor, feeder device 71, or any other suitable conveyance which may be used to communicate the milling mixture 55 from the second elongated runner 22 onto the grizzly screen 13. In alternative embodiments, the apparatus 100 may comprise a second doubleback coupling 32, third elongated runner 23, third doubleback coupling 33, fourth elongated runner 24, fourth doubleback coupling 34, fifth elongated runner 25, fifth doubleback coupling 35, and/or sixth elongated runner 26 which may be used to communicate the milling mixture 55 from the second elongated runner 22 onto the grizzly screen 13. In still further embodiments, the apparatus 100 may comprise any number of elongated runners, preferably angled between −5 and −85 degrees relative to horizontal 201, and any number of doubleback couplings, preferably used to change the direction of a milling mixture 55 that enters the doubleback couplings, which may be used to communicate the milling mixture 55 from the second elongated runner 22 onto the grizzly screen 13.

In some embodiments, the method 500 may comprise the optional step 508 in which grinding media 51 from the milling mixture 55, and optionally grindable material 52 and grinding fluid 53, may be communicated to the intake 11 via a feeder device 71. In further embodiments, the feeder device 71 may comprise a bucket conveyor feeder device, a belt conveyor feeder device, a spiral conveyor feeder device, an auger conveyor feeder device, and a vibrating conveyor feeder device, or any other suitable automated conveyance method. After step 507 or step 508, the method 500 may finish 509.

While some materials have been provided, in other embodiments, the elements that comprise the apparatus 100 such as the a first elongated runner 21 and one or more optional elongated runners 22, 23, 24, 25, 26, a first doubleback coupling 31 and one or more optional doubleback couplings 32, 33, 34, 35, optional support structure 61, optional feeder device 71, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A gravity aided grinding mill apparatus, the apparatus comprising:
an intake for receiving a grinding media and a grindable material;
a first elongated runner in communication with the intake, wherein the first elongated runner is angled between −5 and −85 degrees relative to horizontal;
a first doubleback coupling in communication with the first elongated runner, wherein the first doubleback coupling changes the direction of travel of grinding media and grindable material received from the first elongated runner
a second elongated runner in communication with the first doubleback coupling, wherein the second elongated runner receives the grinding media and grindable material from the first doubleback coupling, and wherein the second elongated runner is angled between −5 and −85 degrees relative to horizontal;
an output in communication with the second elongated runner; and
a grizzly screen in communication with the output, wherein the grizzly screen comprises an exit aperture that is smaller in size than the grinding media.

2. The apparatus of claim 1, wherein an elongated runner is angled between −10 and −45 degrees relative to horizontal, and wherein the runner is selected from the group consisting essentially of: the first elongated runner and the second elongated runner.

3. The apparatus of claim 1, further comprising a feeder device for communicating grinding media from the grizzly screen to the intake.

4. The apparatus of claim 1, wherein the feeder device selected from group consisting essentially of a bucket conveyor feeder device, a belt conveyor feeder device, a spiral conveyor feeder device, an auger conveyor feeder device, and a vibrating conveyor feeder device.

5. The apparatus of claim 1, wherein the grinding media and grindable material are incorporated into a grinding fluid.

6. The apparatus of claim 5, wherein the pulp density of the grinding media, grindable material, and grinding fluid is between 5 to 65 percent solids.

7. The apparatus of claim 1, wherein the size ratio of the grinding media to grindable material size is between 5:1 and 25:1.

8. The apparatus of claim 1, further comprising second doubleback coupling in communication with the second elongated runner and the output, wherein the second doubleback coupling changes the direction of travel of grinding media and grindable material received from the second elongated runner.

9. The apparatus of claim 8, further comprising a third elongated runner in communication with the second doubleback coupling, wherein the third elongated runner receives the grinding media and grindable material from the second doubleback coupling, and wherein the third elongated runner is angled between −5 and −85 degrees relative to horizontal.

10. The apparatus of claim 9, wherein an elongated runner is angled between −10 and −45 degrees relative to horizontal, and wherein the runner is selected from the group consisting essentially of: the first elongated runner, the second elongated runner, and the third elongated runner.

11. A gravity aided grinding method using a gravity aided grinding mill apparatus,
the apparatus comprising:
an intake for receiving a grinding media and a grindable material;
a first elongated runner in communication with the intake, wherein the first elongated runner is angled between −5 and −85 degrees relative to horizontal;
a first doubleback coupling in communication with the first elongated runner, wherein the first doubleback coupling changes the direction of travel of grinding media and grindable material received from the first elongated runner
a second elongated runner in communication with the first doubleback coupling, wherein the second elongated runner receives the grinding media and grindable material from the first doubleback coupling, and wherein the second elongated runner is angled between −5 and −85 degrees relative to horizontal;
an output in communication with the second elongated runner; and
a grizzly screen in communication with the output, wherein the grizzly screen comprises an exit aperture that is smaller in size than the grinding media,
the method comprising the steps of:
communicating a milling mixture comprising grinding media and a grindable material into the first elongated runner via the intake;
gravitationally accelerating the milling mixture in a first direction along the first elongated runner into the first doubleback coupling;
changing the direction of travel of the milling mixture from the first direction to a second direction within the first doubleback coupling;
communicating the milling mixture from the first doubleback coupling into the second elongated runner;
gravitationally accelerating the milling mixture in a second direction along the second elongated runner; and
communicating the milling mixture from the second elongated runner onto the grizzly screen.

12. The method of claim 11, wherein an elongated runner is angled between −10 and −45 degrees relative to horizontal, and wherein the runner is selected from the group consisting essentially of: the first elongated runner and the second elongated runner.

13. The method of claim 11, further comprising a feeder device for communicating grinding media from the grizzly screen to the intake.

14. The method of claim 11, wherein the feeder device selected from group consisting essentially of a bucket conveyor feeder device, a belt conveyor feeder device, a spiral conveyor feeder device, an auger conveyor feeder device, and a vibrating conveyor feeder device.

15. The method of claim 11, wherein the grinding media and grindable material are incorporated into a grinding fluid.

16. The method of claim 15, wherein the pulp density of the grinding media, grindable material, and grinding fluid is between 5 to 65 percent solids.

17. The method of claim 11, wherein the size ratio of the grinding media to grindable material size is between 5:1 and 25:1.

18. The method of claim 11, further comprising second doubleback coupling in communication with the second elongated runner and the output, wherein the second doubleback coupling changes the direction of travel of grinding media and grindable material received from the second elongated runner.

19. The method of claim 18, further comprising a third elongated runner in communication with the second doubleback coupling, wherein the third elongated runner receives the grinding media and grindable material from the second doubleback coupling, and wherein the third elongated runner is angled between −5 and −85 degrees relative to horizontal.

20. The method of claim 19, wherein an elongated runner is angled between −10 and −45 degrees relative to horizontal, and wherein the runner is selected from the group consisting essentially of: the first elongated runner, the second elongated runner, and the third elongated runner.
